(19) United States
(12) Patent Application Publication
(10) Pub. No.: US 2016/0002067 A1
(43) Pub. Date: Jan. 7, 2016

(54) IMMOBILIZED LIGANDS FOR THE REMOVAL OF METAL IONS AND METHODS THEREOF

(71) Applicant: THE CURATORS OF THE UNIVERSITY OF MISSOURI, Columbia, MO (US)

(72) Inventors: Christopher Spilling, St. Louis, MO (US); Wesley Harris, St. Louis, MO (US); Surendra Dawadi, St. Paul, MN (US); Bruce Hamper, Kirkwood, MO (US)

(21) Appl. No.: 14/769,745

(22) PCT Filed: Feb. 21, 2014
(86) PCT No.: PCT/US14/17685

§ 371 Date: Aug. 21, 2015

Related U.S. Application Data
(60) Provisional application No. 61/850,762, filed on Feb. 22, 2013.
(60) Provisional application No. 61/850,781, filed on Feb. 22, 2013.

(51) Int. Cl. C02F 1/28; C08F 112/08

(52) U.S. Cl. CPC C02F 1/285; C08F 112/08; C02F 2101/103

(57) ABSTRACT

Disclosed are immobilized dimercapto succinate compounds (immobilized dithiol compounds), a method to synthesize these immobilized dithiol compounds, and a method of using the immobilized dithiol compounds to remove metals, such as lead, cadmium and mercury from an aqueous solution. Also disclosed are immobilized mono- and di-citrate compounds (immobilized citrate compounds), a method to synthesize these solid-supported compounds, and a method of using the immobilized citrate compounds to remove trivalent metals, such as iron and aluminum from an aqueous solution.

### CROSS REFERENCE TO RELATED APPLICATIONS

This application claims the benefit of U.S. Provisional Application No. 61/850,762, filed Feb. 22, 2013, and U.S. Provisional Application No. 61/850,781, filed Feb. 22, 2013, both of which are hereby incorporated herein by reference in their entireties.

### STATEMENT REGARDING FEDERALLY SPONSORED RESEARCH

This invention was made with Government support under Grant No. 2R42HD055009-02 awarded by the National Institutes of Health. The Government has certain rights in the invention.

### BACKGROUND OF THE INVENTION

Resins capable of removing hazardous metal ions from water, including for the treatment of run off and waste water and purification of drinking water, are known. An effective resin is one which allows production of large volumes of purified water, while concentrating the metals into a small volume for recycling or disposal. Several resins have been prepared in which chelating agents are covalently linked to polymer beads. Compared with simple ion exchange resins, the use of immobilized chelating agents allows one to achieve both higher binding affinities and greater selectivity among different metal ions. This selectivity can be easily understood in terms of the well-known principles of hard-soft acid-base theory (Huheey J E. Inorganic Chemistry, third ed. New York: Harper & Row, 1983). A limitation of many of the known chelating resins, however, is that they immobilize generic, nonspecific ligands.

Several soft metals (Pb, Hg, Cd, As) are high priority environmental contaminants. The 1997 CERCLA Priority List of Hazardous Substances includes lead, mercury, and cadmium within the first 10 positions. Lead is ranked #2 on the CERCLA list and is one of the most widely recognized environmental hazards.

Since the mid-seventies, the average blood lead level in the United States has fallen from 17 μg/dL to 6 μg/dL, due in large part to the reduction in the use of leaded gasoline (Little D N. Children and environmental toxins. Primary Care 1995; 22:69-79; Graeme K A, Pollack C V. Heavy metal toxicity, Part II: Lead and metal fume fever. J. Emerg. Med. 1998; 16:171-177). Even as the United States has reduced the exposure to environmental lead, the perceived “safe” level for blood lead has also dropped. In 1991, the Centers for Disease Control reduced the recommended maximum blood lead level from 25 μg/dL to 10 μg/dL (Little 1995). One concern is that chronic exposure of children to even low lead levels has been associated with subtle reductions in cognitive abilities (Finkelstein Y, Markowitz M E, Rosen J F. Low-level lead induced neurotoxicity in children: an update on central nervous system effects. Brain Res. Rev. 1998; 27:168-176; Wasserman G A, Liu X, Lolacono N J, Factor-Litvak P, Kline J K, Popovac D, Morina N, Musabegovic A, Vrenezi N, Capuni-Paracka S, Lekic V, Preteni-Redjepi E, Hadzialjevic S, Slavkovich V, Graziano J H. Lead exposure and intelligence in 7-year-old children: The Yugoslavia prospective study. Env. Health Persp. 1997; 105:956-962; 26. Burns J M, Baghurst P A, Sawyer M G, McMichael A J, Tong S. Lifetime low-level exposure to environmental lead and children's emotional and behavioral development at ages 11-13 years. Am. J. Epidem. 1999; 149:740-749.), and no clear threshold for these effects has been established (Finkelstein 1998).

Thus, there remains a need to provide new and improved immobilized ligands and methods designed to target specific metal ions (or groups of metals) to improve their removal.

### SUMMARY OF THE INVENTION

Certain aspects of the invention are drawn to a composition for the removal of metal ions from an aqueous solution. In certain embodiments, the composition comprises a ligand immobilized to a polymer. In certain embodiments, the ligand comprises or consists of a dithiol compound. In certain embodiments, the ligand comprises or consists of a citrate compound.

Certain aspects of the invention are drawn to a method for the removal of metal ions from an aqueous solution. In certain embodiments, the method comprises contacting the aqueous solution with a composition comprising a ligand immobilized to a polymer. In certain embodiments, the ligand comprises or consists of a dithiol compound. In certain embodiments, the ligand comprises or consists of a citrate compound. The ligand complexes or chelates the metal ions, thus removing them from the aqueous solution. Illustrative non-limiting examples include: lead, mercury, cadmium, and arsenic ions, and trivalent metal ions.

Certain aspects of the invention are drawn to a method for producing a composition for the removal of metal ions from an aqueous solution. In certain embodiments, the method comprises immobilizing at least one ligand to a polymer. In certain embodiments, the ligand comprises or consists of a dithiol compound. In certain embodiments, the ligand comprises or consists of a citrate compound.

These and other aspects of the invention will become apparent to those skilled in the art in light of the following disclosure and accompanying drawings.

### BRIEF DESCRIPTION OF THE DRAWINGS

FIG. 1. Preparation of dithioacetyl succinic anhydride 4.

FIG. 2. Reaction of benzylamine 5 with dithioacetyl succinic anhydride 4 to produce dithiol ligand 8.

FIG. 3. Immobilization of dithioacetyl succinic anhydride 4 on polystyrene 9.

FIG. 4. Immobilization of dithioacetyl succinic anhydride 4 on branched polyamine linker scaffolds 15a,b,c,d.

FIG. 5. Immobilized citrate compounds 21 and 22.

FIG. 6. Species distribution diagram of Fe³⁺ in a solution of AHA and the resin 1(2) at pH 3-9.

FIG. 7. Reaction of benzylamine 24 with citric anhydride 23 to produce methyl esters 27 and 28.

FIG. 8. Immobilization of citric anhydride 23 on aminomethyl polystyrene resin.

FIG. 9. Immobilization of citric anhydride on branched polyamine linker scaffolds 31a,b.

FIG. 10: The removal of Fe³⁺ from AHA by resin 21(22).

FIG. 11: Species distribution diagram of Fe³⁺ in a solution of AHA and resin-31a or 31b at pH 2-7.

FIG. 12: The removal of Fe³⁺ from AHA by resin 31a.

FIG. 13: The removal of Fe³⁺ from AHA by resin 31b.

### DETAILED DESCRIPTION

In the following detailed description, numerous specific details are set forth in order to provide a thorough understanding of the invention. The following disclosed embodiments, however, are merely representative of the invention which may be embodied in various forms. It will be understood by those skilled in the art that the present invention may be practiced without these specific details. Thus, specific structural, functional, and procedural details described are not to be interpreted as limiting. In other instances, well-known methods, procedures, and components have not been described in detail so as not to obscure the present invention.

Headings are provided herein solely for ease of reading and should not be interpreted as limiting.

Unless otherwise defined, all technical and scientific terms used herein have the same meaning as commonly understood by one of ordinary skill in the art to which this invention pertains.

### Immobilized Dithiol Compounds.

It has been discovered that a series of immobilized compounds are useful for the removal of metal ions from aqueous solutions. For example, a series of immobilized dithiol compounds are disclosed for the removal of soft metals in water, as well as a method to synthesize these compounds and applications thereof. Thiol ligands form very stable metal complexes with soft metals (Martell A E, Smith R M. Critical Stability Constants, New York: Plenum, 1974), but their use can be limited by the tendency to air-oxidize to disulfides (Bertini V, Lucchesini F, Pocci M, De Munno A. 1,3-Dithiane polymers for the supported synthesis of ketones. Tet. Lett. 1998; 39:9266). The dithiolate ligand dimercaptosuccinic acid (DMSA or succimer) is unusually air-stable. This ligand has been extensively studied for use in chelation therapy to treat lead and cadmium poisoning (Aposhian H V, Aposhian M M. Meso-2,3-dimercaptosuccinic acid: Chemical, pharmacological and toxicological properties of an orally effective metal chelating agent. Ann. Rev. Pharmacol. Toxicol. 1990; 30:279-306), and is approved as an oral drug for treating lead toxicity in children (Jorgensen F M. Succimer: The first approved oral lead chelator. Am. Fam. Physician 1993; 48:1496-1502). At neutral pH DMSA binds lead through its two thiol groups, and forms a very stable 1:1 complex (Harris W R, Chen Y, Stenback J, Shah B. Stability constants for dimercaptosuccinic acid with bismuth(III), zinc(II), and lead(II). J. Coord. Chem. 1991; 23:173-186). No 2:1 complex forms even in the presence of a modest excess of ligand. It is contemplated that this concept can be applied to other polythiol ligands and polymers for immobilization.

### Immobilized Citrate Compounds.

It has been discovered that a series of immobilized citrate compounds are useful for the removal of metal ions from aqueous solutions. In particular, two illustrative series of immobilized mono- and di-citrate compounds for the removal of trivalent metal ions in water are disclosed herein, as well as a method to synthesize these compounds and applications thereof.

It was discovered that a series of hydroxamate-based chelating resins were effective for the removal of aluminum (and other trivalent metals) from neutral aqueous solutions. However, the effective binding of trivalent metals to hydroxamates diminishes at low pH. Since waste water streams (and other aqueous solutions) can be acidic, a new system was needed which would operate at low pH. It is contemplated that immobilized citramide 21 (or 22) possess desired characteristics for the removal of aluminum (and other trivalent metals) from aqueous solutions.

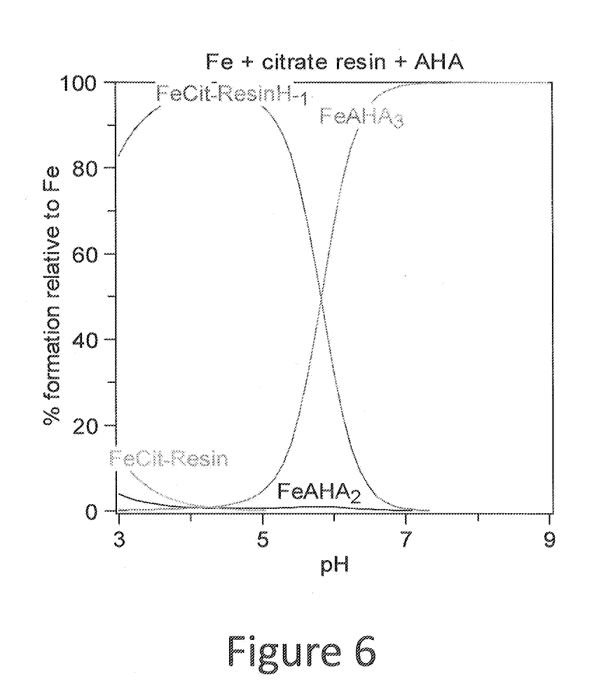

An equilibrium model for the mixture of resin 21, Fe³⁺ and acetohydroxamic acid (AHA) was constructed within the speciation software HySS. AHA is used as a competing ligand. The model included literature values for protonation and Fe binding constants for citrate (assuming binding of a solution phase citrate is similar to that of a resin immobilized citrate) and AHA as fixed parameters. An effective concentration for the immobilized citrate was calculated by dividing the total mmoles of citrate on the resin by the total sample volume. The concentration of AHA was manually varied until the speciation calculation matched about 50% distribution of Fe³⁺ between the resin and AHA at pH 6. Concentrations of 10 mM AHA and 45.9 mM citrate gave about 1:1 distribution of Fe³⁺ (0.1 mM) between these species at pH 6. The predicted speciation of the mixture of Fe³⁺, resin 21 and AHA as a function of pH is shown in FIG. 6. The result also indicates that the resin should bind essentially 100% of the Fe³⁺ below pH 5 at above mentioned concentrations. Above pH 5, AHA complex begins to compete with the resin for the Fe³⁺, and the well-known Fe(AHA)₃ complex is the only iron species present above pH 7.

### Compositions for Removing Metal Ions.

Certain aspects of the invention are directed to compositions for the removal of metal ions from an aqueous solution. Such aqueous solutions include those that naturally contain metal ions, including but not limited to lake, river, stream, ocean water, and the like, or aqueous solutions that have been contaminated by human activity with metal ions. Such compositions are useful, for example, in the treatment of run off and waste water and the purification of drinking water. In certain embodiments, the composition comprises a ligand that is immobilized to a polymer. In certain embodiments, the ligand is a ligand that binds to at least one metal ion. In certain embodiments, the ligand is a ligand that selectively binds certain metal ions or groups of metals over others. In certain embodiments, the ligand comprises a dithiol compound. In certain embodiments, the ligand consists of a dithiol compound. In certain embodiments, the ligand comprises a citrate compound. In certain embodiments, the ligand consists of a di-citrate compound.

In certain embodiments of a composition for the removal of metal ions, the ligand is immobilized to the polymer by a covalent bond. In certain embodiments of a composition for the removal of metal ions, the ligand is immobilized to the polymer through a branched linked scaffold. Multiple methods of providing a covalent linkage between two or more molecules exist. In certain embodiments of a composition for the removal of metal ions, the ligand is immobilized to the polymer through an amide linkage or an ester linkage.

In certain embodiments of a composition for the removal of metal ions, the polymer comprises polystyrene, polyacrylate, sepharose, and/or silica gel. In certain embodiments of a composition for the removal of metal ions, the composition comprises a polymer substrate. In certain embodiments of a composition for the removal of metal ions, the composition comprises a polymer bead. In certain embodiments of a composition for the removal of metal ions, the composition comprises a polymer resin.

As noted above, in certain embodiments, the ligand comprises or consists of a dithiol compound. An illustrative, non-limiting example, of useful dithiol compounds includes dimercaptosuccinic acid. Thus, in certain embodiments, the composition for the removal of metal ions forms complexes with lead, mercury, cadmium, and/or arsenic ions. For example, in certain embodiments, the composition for the removal of metal ions complexes Pb²⁺.

As noted above, in certain embodiments, the ligand comprises or consists of a citrate compound. Thus, in certain embodiments, the composition for the removal of metal ions complexes a trivalent metal ion. For example, in certain embodiments, the composition for the removal of metal ions complexes Fe³⁺.

### Methods for Removing Metal Ions.

Certain aspects of the invention are directed to methods for the removal of metal ions from an aqueous solution. Such aqueous solutions include those that naturally contain metal ions, including but not limited to lake, river, stream, ocean water, and the like, or aqueous solutions that have been contaminated by human activity with metal ions. Such methods are useful, for example, in the treatment of run off and waste water and the purification of drinking water. In certain embodiments, the methods comprise contacting an aqueous solution with a composition comprising a ligand that is immobilized to a polymer. In certain embodiments of a method for the removal of metal ions from an aqueous solution, the ligand of the composition is a ligand that binds to at least one metal ion. In certain embodiments of a method for the removal of metal ions from an aqueous solution, the ligand of the composition is a ligand that selectively binds certain metal ions or groups of metals over others. In certain embodiments of a method for the removal of metal ions from an aqueous solution, the ligand of the composition comprises a dithiol compound. In certain embodiments of a method for the removal of metal ions from an aqueous solution, the ligand of the composition consists of a dithiol compound. In certain embodiments of a method for the removal of metal ions from an aqueous solution, the ligand of the composition comprises a citrate compound. In certain embodiments of a method for the removal of metal ions from an aqueous solution, the ligand of the composition consists of a di-citrate compound.

In certain embodiments of a method for the removal of metal ions from an aqueous solution, the ligand of the composition is immobilized to the polymer of the composition by a covalent bond. In certain embodiments of a method for the removal of metal ions from an aqueous solution, the ligand is immobilized to the polymer through a branched linked scaffold. Multiple methods of providing a covalent linkage between two or more molecules exist. In certain embodiments of a method for the removal of metal ions from an aqueous solution, the ligand is immobilized to the polymer through an amide linkage or an ester linkage.

In certain embodiments of a method for the removal of metal ions from an aqueous solution, the polymer of the composition comprises polystyrene, polyacrylate, sepharose, or silica gel. In certain embodiments of a method for the removal of metal ions from an aqueous solution, a composition of the method comprises a polymer substrate. In certain embodiments of a method for the removal of metal ions from an aqueous solution, a composition comprises a polymer bead. In certain embodiments of a method for the removal of metal ions from an aqueous solution, a composition comprises a polymer resin.

As noted above, in certain embodiments of a method for the removal of metal ions from an aqueous solution, a ligand of the composition comprises or consists of a dithiol compound. An illustrative, non-limiting example, of useful dithiol compounds includes dimercaptosuccinic acid. Thus, in certain embodiments, the method for the removal of metal ions from an aqueous solution removes: lead; mercury; cadmium; and/or arsenic ions. For example, in certain embodiments, the method for the removal of metal ions from an aqueous solution removes Pb²⁺.

As noted above, in certain embodiments of a method for the removal of metal ions from an aqueous solution, a ligand of the composition comprises or consists of a citrate compound. Thus, in certain embodiments, the method for the removal of metal ions from an aqueous solution removes a trivalent metal ion. For example, in certain embodiments, the method for the removal of metal ions from an aqueous solution removes Fe³⁺.

As noted above, in certain embodiments of the method of removing metal ions from an aqueous solution, the ligand of the composition comprises or consists of a citrate compound and the composition comprising the ligand immobilized to a polymer is contacted with an aqueous solution with a pH of about 5 or less.

### Methods for Producing a Composition for Removing Metal Ions.

Certain aspects of the invention are directed to methods for producing a composition for the removal of metal ions from an aqueous solution. Such aqueous solutions include those that naturally contain metal ions, including but not limited to lake, river, stream, ocean water, and the like, or aqueous solutions that have been contaminated by human activity with metal ions. Compositions produced by such methods are useful, for example, in the treatment of run off and waste water and the purification of drinking water. In certain embodiments, the methods comprise immobilizing a ligand to a polymer. In certain embodiments of a method for producing a composition for removing metal ions from an aqueous solution, the ligand of the composition is a ligand that binds to at least one metal ion. In certain embodiments of a method for producing a composition for removing metal ions from an aqueous solution, the ligand of the composition is a ligand that selectively binds certain metal ions or groups of metals over others. In certain embodiments of a method for producing a composition for removing metal ions from an aqueous solution, the ligand of the composition comprises a dithiol compound. In certain embodiments of a method for producing a composition for removing metal ions from an aqueous solution, the ligand of the composition consists of a dithiol compound. In certain embodiments of a method for producing a composition for removing metal ions from an aqueous solution, the ligand of the composition comprises a citrate compound. In certain embodiments of a method for producing a composition for removing metal ions from an aqueous solution, the ligand of the composition consists of a di-citrate compound.

In certain embodiments of a method for producing a composition for the removal of metal ions from an aqueous solution, the ligand of the composition is immobilized to a polymer of the composition by a covalent bond. In certain embodiments of a method for producing a composition for the removal of metal ions from an aqueous solution, the ligand of the composition is immobilized to the polymer of the composition through a branched linked scaffold. Multiple methods of providing a covalent linkage between two or more molecules exist. In certain embodiments of a method for producing a composition for the removal of metal ions from an aqueous solution, the ligand of the composition is immobilized to the polymer of the composition through an amide linkage or an ester linkage. Representative examples of the immobilization of a ligand to a polymer are illustrated in multiple Examples disclosed herein.

In certain embodiments of a method for producing a composition for the removal of metal ions from an aqueous solution, the polymer comprises polystyrene, polyacrylate, sepharose, or silica gel. In certain embodiments of a method for producing a composition for the removal of metal ions from an aqueous solution, a composition produced by the method comprises a polymer substrate. In certain embodiments of a method for producing a composition for the removal of metal ions from an aqueous solution, a composition produced by the method comprises a polymer bead. In certain embodiments a method for producing a composition for the removal of metal ions from an aqueous solution, a composition produced by the method comprises a polymer resin.

As noted above, in certain embodiments, the ligand of the composition comprises or consists of a dithiol compound. An illustrative, non-limiting example, of useful dithiol compounds includes dimercaptosuccinic acid. Representative examples of the production of useful dithiol compounds are illustrated in the Examples disclosed herein. Thus, in certain embodiments, the composition for the removal of metal ions from an aqueous solution produced by the method complexes: lead; mercury; cadmium; and/or arsenic ions. For example, in certain embodiments, the composition for the removal of metal ions from an aqueous solution produced by the method complexes Pb²⁺.

As noted above, in certain embodiments of a method for producing a composition for removing metal ions from an aqueous solution, the ligand of the composition comprises or consists of a citrate compound. Representative examples of the production of useful citrate compounds are illustrated in the Examples disclosed herein. Thus, in certain embodiments, the composition for the removal of metal ions from an aqueous solution produced by the method complexes a trivalent metal ion. For example, in certain embodiments, the composition for the removal of metal ions from an aqueous solution produced by the method complexes Fe³⁺.

### EXAMPLES

The following disclosed embodiments are merely representative of the invention which may be embodied in various forms. Thus, specific structural, functional, and procedural details disclosed in the following examples are not to be interpreted as limiting.

### Example 1

### Synthesis of Dimercapto Hemisuccinamides

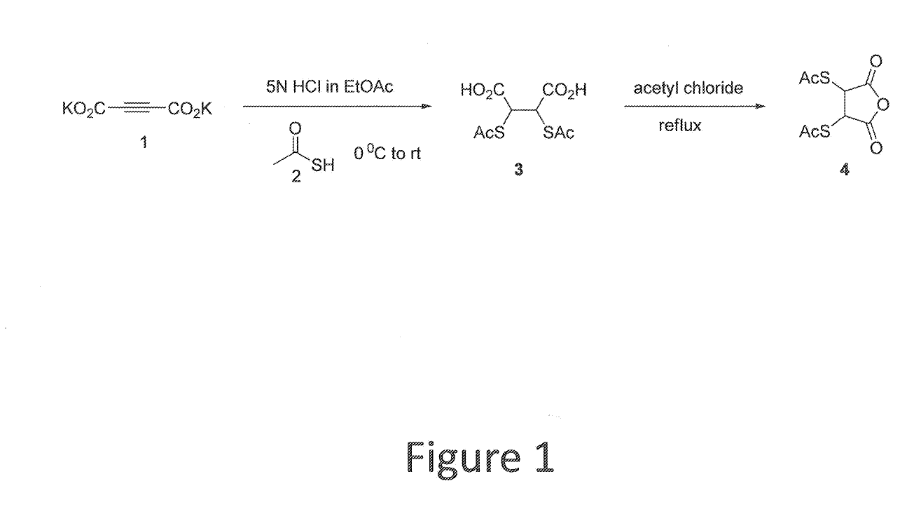

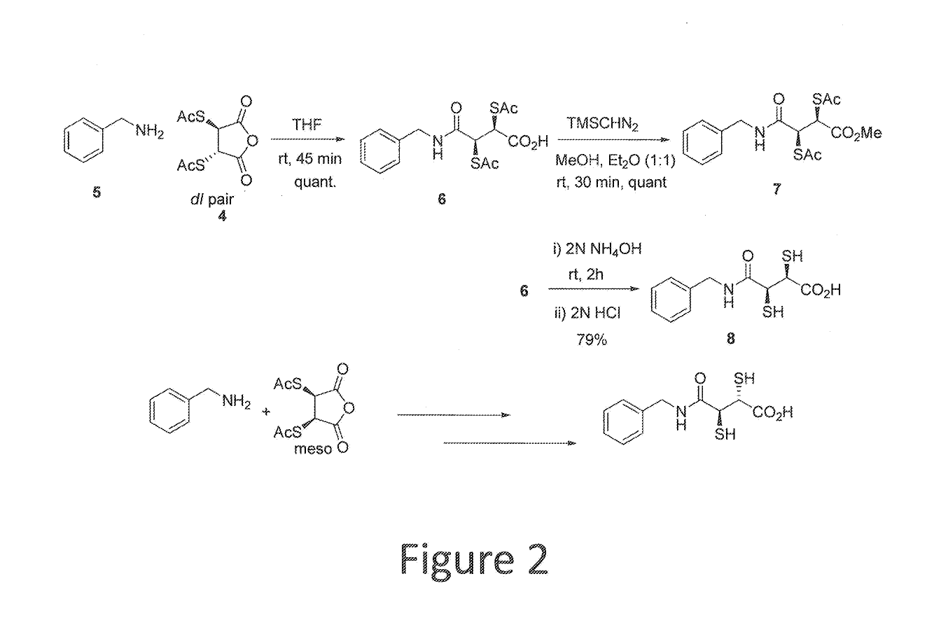

Before immobilizing dithiol succinic acid (via the anhydride) on aminomethyl polystyrene resin or any other primary amine functionalized resins, the feasibility of the proposed chemistry was examined in solution. Reaction of the benzylamine 5 with the known dithioacetyl succinic anhydride 4, prepared following a literature procedure (FIG. 1) (Gerecke M, Friedheim E A H, Brossi A. Zur kenntnis der 2,3-dimercaptobernsteinsauren. Helv. Chim. Acta 1961; 44:953-960; (a) Owen L N, Sultanbawa M U S. Olefinic acids. Part VII. The addition of thiols to propiolic and acetylenedicarboxylic acid. J. Chem. Soc. 1949; 3109-3113. (b) Sulphur-containing dicarboxylic acids and derivatives thereof and a process for the manufacture of same′, patent specification application in Switzerland, 1961, 6911/61) gave the acetyl protected hemisuccinamide 6 (FIG. 2) which was characterized as the methyl ester 7. The methyl ester 7 was prepared by reaction with TMS diazomethane, purified by silica gel column chromatography and fully characterized. Deacetylation of the hemisuccinamide 6 with ammonium hydroxide in methanol gave the dithiol ligand 8. The reaction sequence work equally with meso and dl enriched diastereomer mixtures.

### Immobilization on Polystyrene

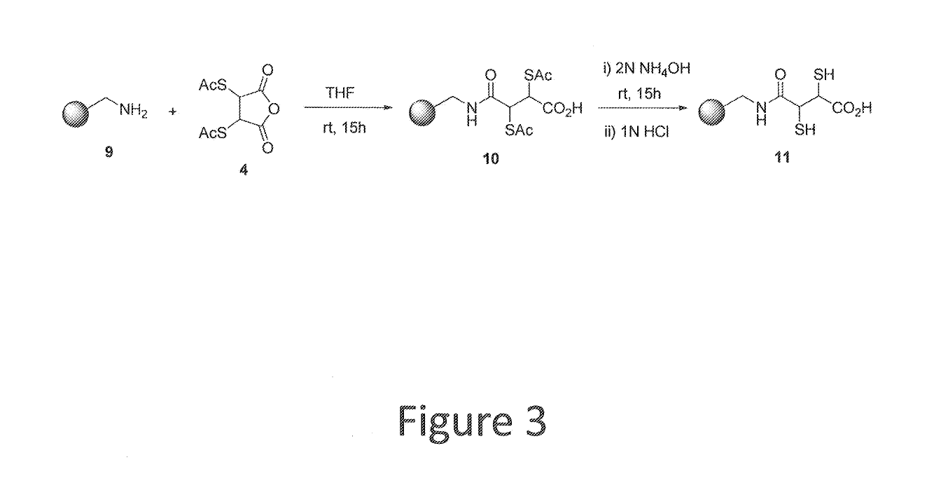

Following the procedures used for the solution phase ligand, aminomethyl polystyrene (2.2 meq/g, 3.52 mmol of —NH₂, Aldrich 564095, macroporous 30-60 mesh) was reacted with dithioacetyl succinic anhydride 4 to give the hemisuccinamide resin 10 (FIG. 3). The ligand loading was 0.68 meq/g (based on S 4.39%=1.38 mmol/g). Deacetylation of the hemisuccinamide 10 with ammonium hydroxide in methanol gave the dithiol resin 11 with a ligand loading of 0.61 meq/g (based on S) (FIG. 3). The S to N ratio was 1:1.5, indicating that approximately 33% of the available amines had reacted. If the reaction was complete, the expected S:N ratio would be 2:1.

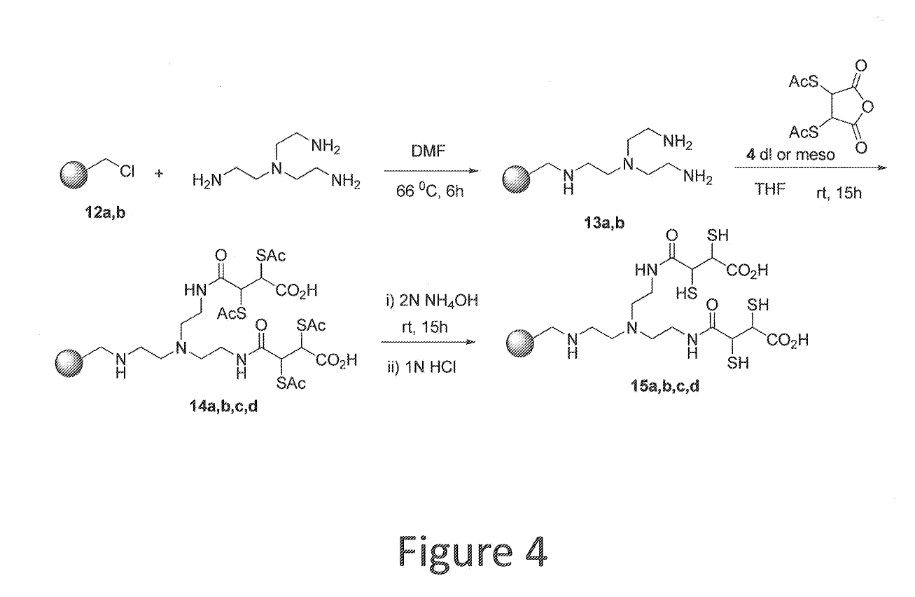

To potentially increase the loading density and provide the opportunity for multiple dithiols to bind to a single metal, branched polyamine linker scaffolds were studied (FIG. 4). Two chloromethyl polystyrene resins 12a (ChemPep G20J1233, 0.82 mmol/g Cl, macroporous 100-200 mesh) and 12b (chloromethylated XAD 4, 1.24 mmol/g of Cl,) were reacted with tris(2-aminoethyl)amine in DMF to give tetra amino resins 13a (0.35 mmol/g) and 13b (0.65 mmol/g) (based on N) (Hodges J. C., Booth R. J. J. Am. Chem. Soc. 1997, 119, 4882). Some cross linking of the resin by the tetramine is expected (i.e., reaction of one tetramine with two chloromethyls). The amino resins were reacted with excess dl and meso enriched dithioacetyl succinic anhydride 4 in THF to give 14a-d (0.28 meq/g, 0.22 meq/g, 0.64 meq/g and 0.50 meq/g of dithioacetyl based on % S). Deacetylation of the hemisuccinamides 14a-d with ammonium hydroxide in methanol gave the dithiol resins 15a-d (0.19 meq/g, 0.15 meq/g, 0.36 meq/g and 0.32 meq/g of dithiol based on % S). Using 15a as an example, a comparison of the % of S and N show that the tetraamines are 60% acylated (or 30% of the available primary amines have acylated) (Table 1).

TABLE 1

| | | | mmol | | | mmol | % NH2 |
|---|---|---|---|---|---|---|---|
| Resin | % S | mmol S | dithiol | % N | mmol N | tetramine | Acylation |
| 11 | 3.89 | 1.22 | 0.61 | 2.56 | 1.83 | N/A | 30% |
| 15a | 1.25 | 0.391 | 0.195 | 1.80 | 1.28 | 0.32 | 30% |
| 15b | 0.99 | 0.31 | 0.155 | 1.81 | 1.28 | 0.32 | 24% |
| 15c | 2.33 | 0.728 | 0.36 | 3.05 | 2.18 | 1.54 | 33% |
| 15d | 2.04 | 0.637 | 0.32 | 3.10 | 2.21 | 0.55 | 29% |

### Study of Pb²⁺ Extraction by Flame Atomic Absorption Spectroscopy (AAS)

A 10 ml solution of Pb(NO₃)₂ (300 μM, 62.1 μg/ml Pb²⁺) in pH 6.7 MES buffer was prepared. Resin 11 (25 mg) was added to the solution and allowed to equilibrate completely by shaking in an orbital shaker for about 22 h. Resin beads were removed by filtration and the amount of Pb remaining in the solution was measured by flame AAS. The instrument was calibrated with five Pb standard solutions 10, 20, 30, 40, and 50 ppm each time before the Pb measurement was performed. Final pH of the mixture after 24 h was measured to be 6.61. The results showed that 68.1 μM (14.1 μg/ml) Pb²⁺ remained in the solution after 24 h. 77% of the Pb²⁺ was bound to the resin and 23% remaining in the solution when equilibrium was achieved. The experiment was performed at various pH values, and the results are summarized in Table 2.

TABLE 2
Pb concentration before and after resin 11 treatment at various pHs.

| | | Pb concentration | Pb concentration | % Pb |
|---|---|---|---|---|
| | Weight | before resin | after 22 h resin | remaining |
| pH | of resin | treatment | treatment | in solution |
| 5.80 | 25.0 mg | 480 μM | 289 μM | 60 |
| 6.58 | 25.0 mg | 300 μM | 72 μM | 24 |
| 6.61 | 25.0 mg | 300 μM | 68 μM | 23 |

Similarly, Pb removal capacity of bis-DMSA functionalized resins is summarized in the following tables.

TABLE 3
Pb concentration before and after
resin 15a treatment at various pHs.

| | | Pb concentration | Pb concentration | % Pb |
|---|---|---|---|---|
| | Wt. of | before resin | after 22 h resin | remaining |
| pH | resin | treatment | treatment | in solution |
| 5.84 | 45.0 mg | 300 μM | 127 μM | 42 |
| 6.56 | 45.0 mg | 300 μM | 5 μM | 1.7 |
| 6.61 | 33.0 mg | 300 μM | 26 μM | 13 |

TABLE 4
Pb concentration before and after
resin 15b treatment at various pHs.

| | | Pb concentration | Pb concentration | % Pb |
|---|---|---|---|---|
| | Wt. of | before resin | after 22 h resin | remaining |
| pH | resin | treatment | treatment | in solution |
| 5.85 | 56.0 mg | 300 μM | 122 μM | 41 |
| 6.56 | 56.0 mg | 300 μM | 3 μM | 1 |
| 6.61 | 41.0 mg | 300 μM | 17 μM | 6 |

TABLE 5
Pb concentration before and after
resin 15c treatment at various pHs.

| | | Pb concentration | Pb concentration | % Pb |
|---|---|---|---|---|
| | Wt. of | before resin | after 22 h resin | remaining |
| pH | resin | treatment | treatment | in solution |
| 5.84 | 25.0 mg | 300 μM | 52 μM | 17 |
| 5.97 | 25.0 mg | 300 μM | 28 μM | 9 |
| 6.54 | 25.0 mg | 300 μM | 2 μM | 0.7 |
| 6.60 | 18.3 mg | 300 μM | 4 μM | 1.3 |

TABLE 6
Pb concentration before and after
resin 15d treatment at various pHs.

| | | Pb concentration | Pb concentration | % Pb |
|---|---|---|---|---|
| | Wt. of | before resin | after 22 h resin | remaining |
| pH | resin | treatment | treatment | in solution |
| 5.84 | 28.0 mg | 300 μM | 45 μM | 15 |
| 6.55 | 28.0 mg | 300 μM | 1 μM | 0.3 |
| 6.61 | 20.5 mg | 300 μM | 3 μM | 1 |

### Additional Procedures

Preparation of dithioacetyl succinic anhydride followed literature procedure and as described above.

2,3-Bis(acetylthio)succinic acid (3) was obtained as a mixture of 55% dl pair and 45% meso isomers. IR (neat) 3400-2500 (br.), 2908, 1698, 1654, 1412, 1125 cm⁻¹; meso: ¹H NMR (MeOD) δ (ppm) 4.85 (s, 1H), 2.37 (s, 3H); ¹³C (MeOD) δ (ppm) 194.8, 172.5, 48.2, 29.8; dl pair: ¹H NMR (MeOD) δ (ppm) 4.61 (s, 1H), 2.38 (s, 3H); ¹³C (MeOD) δ (ppm) 194.1, 172.9, 47.7, 29.9; HRMS (FAB) C₈H₁₁O₆S₂ [M+H]⁺ calcd 266.9997, found 267.0006.

### 2,5-Dioxotetrahydrofuran-3,4-diyl diethanethioate (dithioacetyl succinic anhydride) (4)

IR (neat) 2925 (broad), 1697, 1405 1210 cm⁻¹; meso: ¹H NMR (CDCl₃) δ (ppm) 4.91 (s, 1H), 2.44 (s, 3H); ¹³C (MeOD) δ (ppm) 194.5, 168.1, 45.4, 29.7; dl pair: ¹H NMR (CDCl₃) δ (ppm) 4.21 (s, 1H), 2.45 (s, 3H); ¹³C (MeOD) δ (ppm) 194.4, 166.9, 47.8, 30.0; HRMS (FAB) C₈H₉O₅S₂ [M+H]⁺ calcd 248.9891, found 248.9889.

### Methyl 4-(benzylamino)-2,3-dimercapto-4-oxobutanoate (7)

To a solution of anhydride 4 (pure dl pair, 0.31 g, 1.24 mmol) in THF was added benzylamine (0.15 ml, 1.38 mmol) drop wise and the mixture was stirred at rt. Progress of the reaction was monitored by TLC (50% EtOAc in hexane). Reaction was complete in 45 minutes. To the reaction mixture was added 1N HCl (5 ml) and the mixture was stirred for about 5 minutes. The mixture was extracted with CH₂Cl₂ and the combined organics were dried over Na₂SO₄ and evaporated under reduced pressure to obtain the carboxylic acid 6 (0.43 g, quant.) as a foamy solid.

To a solution of compound 6 (0.09 g, 0.25 mmol) in a 1:1 mixture of MeOH and Et₂O (4 ml) was added trimethylsilyl diazomethane (2M in Et₂O, 0.19 ml, 0.38 mmol) drop wise at room temp. The reaction was vigorous with the evolution of gas and was over immediately after the complete addition of trimethylsilyl diazomethane. The reaction mixture was let stir for a total of 30 min. The solvent was removed under reduced pressure and the crude product was purified by column chromatography (SiO₂, hexane/EtOAc gradient) to give colorless oil product 7 (0.09 g, quant) as a mixture of geometrical (amide) isomers: IR (neat) 3380, 2952, 1733, 1693, 1525 cm⁻¹; ¹H NMR (CDCl₃) δ (ppm) 7.28-7.14 (m, 5H), 6.47 (app t, 1H), 4.80 (ABq, Δδ=42.2 Hz, J=4.3 Hz, 0.7H)+4.58 (ABq, Δδ=68.3 Hz, J=8.2 Hz, 1.3H), 4.34 (t, J=5.9 Hz, 2H), 3.66 (s, 3H), 2.32 (s, 2.1H)+2.31 (s, 3.9H); ¹³C (CDCl₃) δ (ppm) 195.86+195.81, 193.51+192.60, 170.40+170.19, 169.05+168.99, 137.88+137.86, 128.87+128.86, 127.68+127.66, 127.65, 53.41+53.38, 47.39+47.35, 45.87+45.40, 43.93, 30.42, 30.21+30.05; HRMS (FAB) C₁₆H₂₀NO₅S₂ [M+H]⁺ calcd 370.0782, found 370.0786.

General Process I (Immobilization of Anhydride 4 on Amine Functionalized Resins).

To a suspension of resin in THF (6 ml/g of resin) was added anhydride 4 (3 equiv. per —NH₂ of resin) and the mixture was shaken using an orbital shaker for 15 h at rt. The resin was filtered and washed 3 times each with THF, MeOH, H₂O, MeOH and Et₂O. It was then treated with 1N HCl and the mixture was shaken for 20 min. The resin was filtered and washed 3 times each with H₂O, MeOH and Et₂O. The resin was dried under reduced pressure to obtain the product resin.

General Process II (Conversion of Thioacetate to Thiol).

To thioacetate functionalized resin was added 2N NH₄OH (7-35 ml per mmol of −SAC) and the mixture was shaken using an orbital shaker for 15 h at rt. The resin was filtered and washed 3 times with H₂O. It was then treated with 1N HCl (˜7 ml per mmol of −SAc) and the mixture was shaken for 1 h. The resin was filtered and washed 3 times each with H₂O, MeOH and Et₂O. The resin was dried under reduced pressure to obtain thiol functionalized resin.

Resin 10.

Following the general process I, aminomethyl resin (1.6 g, 2.2 meq/g, 3.52 mmol of —NH₂, Aldrich 564095, macroporous 30-60 mesh) was treated with anhydride 4 (dl pair, 2.60 g, 10.47 mmol). Product was dark brown resin beads (2.27 g). IR (ATR): 3420-2500 (br), 3025, 2921, 1715 (C═O acid), 1660, 1605, 1493, 698 cm⁻¹. EA: C, 76.47%; H, 7.07%; N, 2.32%; S, 4.39%. Loading value=0.68 meq/g (based on % S).

Resin 11.

Following the general process II, resin 10 (2.2 g, 0.68 meq/g, 3.00 mmol of −SAc) was treated with 2N NH₄OH (23 ml). Product was dark brown resin beads (1.9 g). Weight lost by the resin=0.3 g. IR (ATR): 3400-2500 (br), 3025, 2921, 1720 (C═O acid), 1655, 1602, 1493, 698 cm⁻¹. EA: C, 77.95%; H, 7.22%; N, 2.56%; S, 3.89%. Loading value=0.61 meq/g (based on % S).

### Polymer-supported tris(2-aminomethyl)amine (13a,b)

13a:

To a suspension of chloromethyl polystyrene resin (3.0 g, 0.82 mmol/g, 2.46 mmol of Cl, ChemPep 020J1233, macroporous 100-200 mesh) in DMF (10 ml) was added tris(2-aminoethyl)amine (1.45 ml, 9.89 mmol) and the suspension was shaken using an orbital shaker for 6 h at 65° C. The resin was filtered and washed 3 times each with DMF, MeOH, Et₃N, MeOH and Et₂O. The resin was then dried under reduced pressure to obtain white colored resin (3.0 g). IR (ATR): 3023, 2921, 1597, 1493, 1452, 697 cm⁻¹. EA: C, 87.96%; H, 7.77%; N, 1.97%; Cl, 0.65%. Loading value=0.35 mmol/g of tetramine (based on % N).

13b:

To a suspension of chloromethyl polystyrene resin (3.0 g, 1.24 mmol/g, 3.72 mmol of Cl, chloromethylated XAD 4) in DMF (10 ml) was added tris(2-aminoethyl)amine (2.17 ml, 14.88 mmol) and shaken using an orbital shaker for 6 h at 65° C. The resin was filtered and washed 3 times each with DMF, MeOH, Et₃N, MeOH and Et₂O. The resin was dried under reduced pressure to obtain white colored resin (3.1 g). IR (ATR): 3370 (br), 3019, 2922, 1603, 1447, 708 cm⁻¹. EA: C, 77.48%; H, 8.01%; N, 3.64%; Cl, 3.70%. Loading value=0.65 mmol/g of tetramine (based on % N).

Resin 14a.

Following the general process I, resin 13a (0.68 g, 0.35 mmol/g, 0.47 mmol of —NH₂) was treated with anhydride 4 (71% dl pair, 0.35 g, 1.43 mmol). Product was light brown colored resin beads (0.74 g). IR (ATR): 3399 (br), 3023, 2922, 1695, 1642 (br, acid carbonyl imbedded inside), 1602, 1493, 1452, 698 cm⁻¹. EA: C, 82.32%; H, 7.47%; N, 1.72%; S, 1.80%. Loading value=0.28 meq/g of dithioacetate (based on % S).

Resin 14b.

Following the general process I, resin 13a (0.68 g, 0.35 mmol/g, 0.47 mmol of —NH₂) was treated with anhydride 11 (80% meso, 0.35 g, 1.43 mmol). Product was light brown colored resin beads (0.73 g). IR (ATR): 3378 (br), 3027, 2922, 1650 (br, acid carbonyl imbedded inside), 1602, 1493, 1451, 698 cm⁻¹. EA: C, 83.24%; H, 7.75%; N, 1.82%; S, 1.43%. Loading value=0.22 meq/g of dithioacetate (based on % S).

Resin 14c.

Following the general process I, resin 13b (0.78 g, 0.65 mmol/g, 1.01 mmol of —NH₂) was treated with anhydride 11 (71% dl pair, 0.76 g, 3.04 mmol). Product was dark brown colored resin beads (0.95 g). IR (ATR): 3401 (br), 2923, 1695, 1638, 1604, 1444, 1115, 707 cm⁻¹. EA: C, 70.21%; H, 7.14%; N, 2.91%; S, 4.05%. Loading value=0.63 meq/g of dithioacetate (based on % S).

Resin 14d.

Following the general process I, resin 13b (0.78 g, 0.65 mmol/g, 1.01 mmol of —NH₂) was treated with anhydride 11 (80% meso, 0.76 g, 3.04 mmol). Product was dark brown colored resin beads (0.94 g). IR (ATR): 3385 (br), 2924, 1695, 1633, 1605, 1444, 1115, 707 cm⁻¹. EA: C, 71.28%; H, 7.26%; N, 2.91%; S, 3.25%. Loading value=0.51 meq/g of dithioacetate (based on % S).

Resin 15a.

Following the general process II, resin 14a (0.70 g, 0.14 meq/g, 0.39 mmol of —SAc) was treated with 2N NH₄OH (14 ml). Product was beige colored resin beads (0.49 g). IR (ATR): 3403 (br), 3025, 2922, 1715 (C═O acid), 1650, 1602, 1493, 1451, 698 cm⁻¹. EA: C, 83.50%; H, 7.45%; N, 1.80%; S, 1.25%. Loading value=0.19 meq/g of dithiol (based on % S).

Resin 15b.

Following the general process II, resin 14b (0.70 g, 0.11 meq/g, 0.31 mmol of —SAc) was treated with 2N NH₄OH (14 ml). Product was beige colored resin beads (0.52 g). IR (ATR): 3403 (br), 3025, 2922, 1715 (C═O acid), 1650, 1602, 1493, 1452, 698 cm⁻¹. EA: C, 83.99%; H, 7.47%; N, 1.81%; S, 0.99%. Loading value=0.15 meq/g of dithiol (based on % S).

Resin 15c.

Following the general process II, resin 14c (0.91 g, 0.32 meq/g, 1.16 mmol of —SAc) was treated with 2N NH₄OH (18 ml). Product was brown resin beads (0.79 g). IR (ATR): 3384 (br), 3018, 2923, 1705 (C═O acid), 1634, 1445, 708 cm⁻¹. EA: C, 70.51%; H, 7.21%; N, 3.05%; S, 2.33%. Loading value=0.36 meq/g of dithiol (based on % S).

Resin 15d.

Following the general process II, resin 14d (0.90 g, 0.25 meq/g, 0.90 mmol of —SAc) was treated with 2N NH₄OH (18 ml). Product was brown resin beads (0.78 g). IR (ATR): 3396 (br), 3018, 2924, 1705 (C═O acid), 1636, 1445, 708 cm⁻¹. EA: C, 70.74%; H, 7.66%; N, 3.10%; S, 2.04%. Loading value=0.32 meq/g of dithiol (based on % S).

### Example 2

### Synthesis of the Citramides

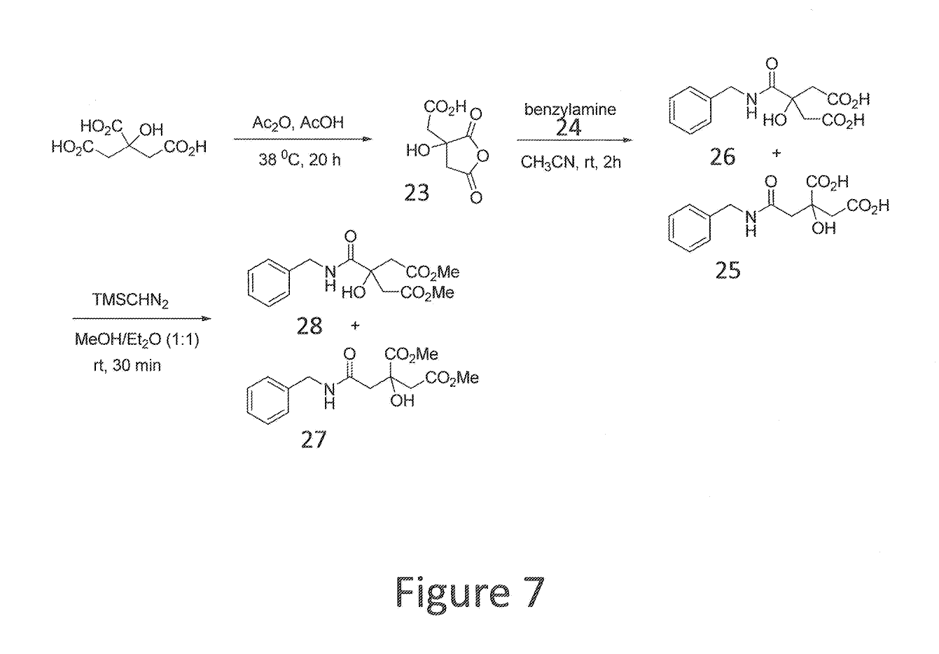

Before immobilizing citric acid (via the anhydride) on aminomethyl polystyrene resin or any other primary amine functionalized resins, the feasibility of the proposed chemistry was examined in solution. Reaction of the benzylamine 24 with the known citric anhydride 23, prepared following a literature procedure, gave the benzyl citramides 25 and 26 (FIG. 7) in a 1:2 ratio. The citramides were converted to the methyl esters 27 and 28. The methyl esters 27 and 28 were purified by silica gel column chromatography and fully characterized.

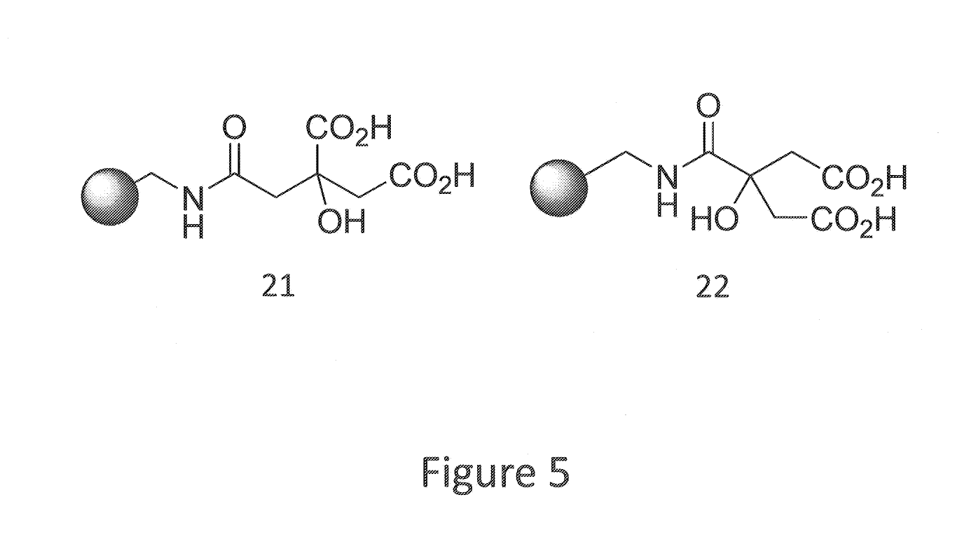

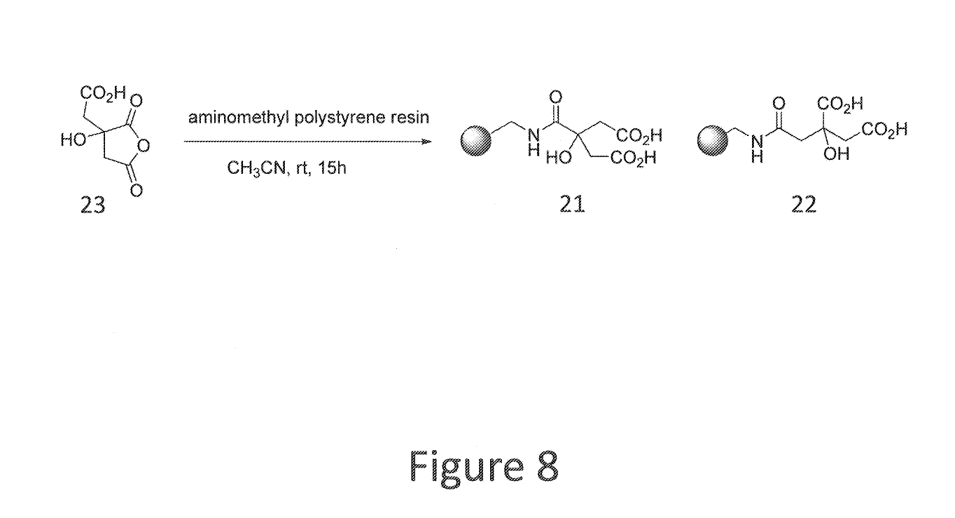

Following the procedures used for the solution phase ligand, aminomethyl polystyrene (2.2 meq/g, of —NH₂, Aldrich 564095, macroporous 30-60 mesh) was reacted with citric anhydride to the citramide resin. From the solution studies, it is assumed that the resin is a mixture of 21 and 22 (FIGS. 5 and 8).

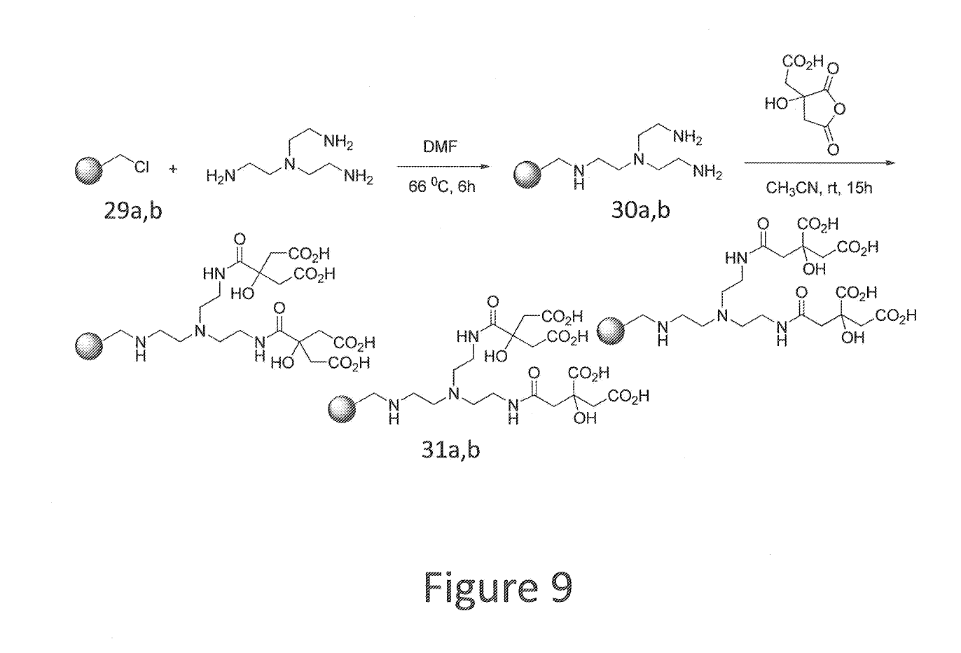

To potentially increase the loading density and provide the opportunity for multiple carboxylates to bind to a single metal, branched polyamine linker scaffolds were studied (FIG. 9). Two chloromethyl polystyrene resins 29a (ChemPep G20J1233, 0.82 mmol/g Cl, macroporous 100-200 mesh) and 29b (chloromethylated XAD 4, 1.24 mmol/g of Cl,) were reacted with tris(2-aminoethyl)amine in DMF to give tetra amino resins 30a (0.35 mmol/g) and 30b (0.65 mmol/g) (of tetramine based on N). The amino resins were reacted with excess citric anhydride in acetonitrile to give 31a and 31b. The resin is likely to contain both citramide regioisomers giving rise to multiple resin species. The observed binding may be an average of the biding of individual species.

### Study of Fe³⁺ Extraction by UV-Vis Spectroscopy

Resin 1(2).

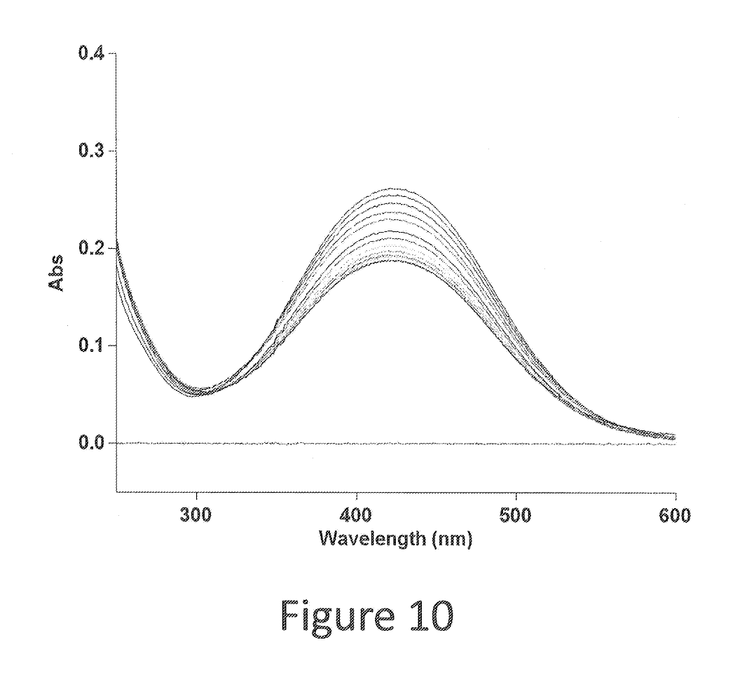

A 2 ml mixture of Fe³⁺ (100 μM) and the chelating agent AHA (10 mM) in pH 6.2 MES buffer was prepared, allowed to equilibrate, and the absorbance was recorded. Resin 21(22) (60 mg) was added to the solution and the absorbance was recorded periodically. The removal of Fe³⁺ from the Fe-A H A complex by the resin was indicated by the decrease in the absorbance band of the Fe(AHA)₃ complex at 422 nm, as shown in FIG. 10. Absorbance kept decreasing until the equilibrium was reached. Thus the lowest absorbance in the figure represents an equilibrium distribution of the Fe³⁺ between AHA and the resin. The fraction of Fe³⁺ bound to the resin was calculated by comparing the final absorbance spectrum to that of the Fe(AHA)₃ complex before the addition of resin. The results showed that 28% of the Fe³⁺ was bound to the resin and 72% to AHA when the equilibrium was achieved.

Resin 31a and 31b.

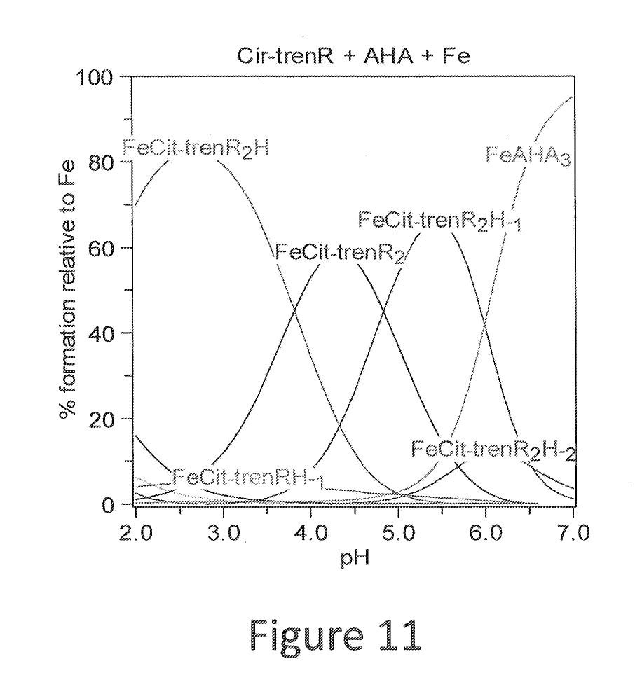

An equilibrium model for the mixture of resin 31a or 31 b, Fe³⁺ and acetohydroxamic acid (AHA) was constructed within the speciation software HySS. The model included literature values for protonation and Fe binding constants for citrate (assuming binding of a solution phase citrate is similar to that of a resin immobilized citrate) and AHA as fixed parameters. As resins 31a and 31b contain di-citrate system, β₁₂₀, β₁₂₁ and β₁₂₋₁ constants of the citrate were also included. Concentration of AHA was manually varied keeping the concentration of citrate resin constant (same as previous mono-citrate system) until the speciation calculation matched about 50% distribution of Fe³⁺ between the resin and AHA. Concentrations of 30 mM AHA and 45.9 mM citrate gave about 1:1 distribution of Fe³⁺ (0.1 mM) between these species at pH 6. The predicted speciation of the mixture of Fe³⁺, resin 31a or 31b and AHA as a function of pH is shown in FIG. 11. The result also indicates that the resin should bind essentially 100% of the Fe³⁺ below pH 5 at above mentioned concentrations. Above pH 5, AHA complex begins to compete with the resin for the binding of Fe³⁺, and the Fe(AHA)₃ complex is the only iron-containing species above pH 7.

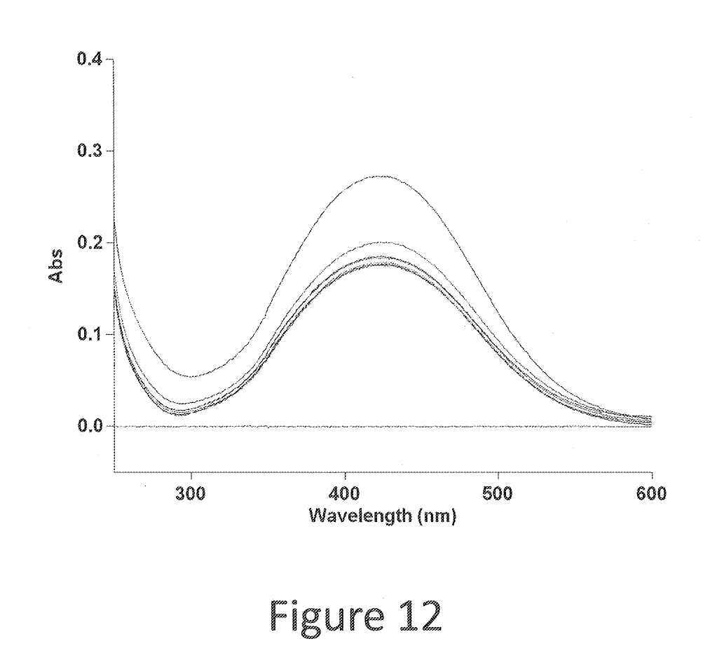

A 2 ml mixture of Fe³⁺(100 μM) and the chelating agent AHA (40 mM) in pH 6.2 MES buffer was prepared, allowed to equilibrate, and the absorbance was recorded. Resin 31a (65 mg) was added to the solution and the absorbance was recorded periodically. The removal of Fe³⁺from the Fe(AHA)₃ complex by the resin was indicated by the decrease in the absorbance band of the Fe(AHA)₃ complex at 422 nm, as shown in FIG. 12. The lowest absorbance in the figure represents an equilibrium distribution of the Fe³⁺between AHA and the resin. The results showed that 36% of the Fe³⁺was bound to the resin and 64% to AHA when the equilibrium was achieved.

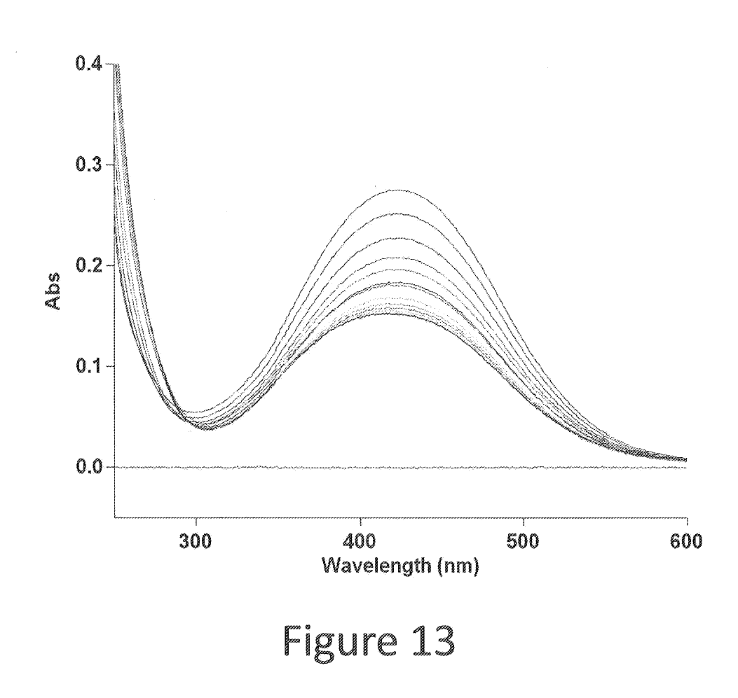

A 2 ml mixture of Fe³⁺(100 μM) and the chelating agent AHA (60 mM) in pH 6.2 MES buffer was prepared, allowed to equilibrate, and the absorbance was recorded. Resin 31 b (38 mg) was added to the solution and the absorbance was recorded periodically. The removal of Fe³⁺from the Fe(AHA)₃ complex by the resin was again indicated by the decrease in the absorbance band of the Fe-A H A complex at 422 nm, as shown in FIG. 13. The results showed that 44% of the Fe³⁺was bound to the resin and 56% to AHA when the equilibrium was achieved.

### Additional Procedures

Citric Acid Anhydride (23).

Compound reference: Repta A. J.; Higuchi T. Journal of Pharmaceutical sciences 1969, 58 (9), 1110. Spectral data was not provided. IR (neat) 3454, 3186, 1856, 1772, 1731, 1692, 1179 cm⁻¹; ¹H NMR (acetone-d6) δ (ppm) 3.26 (ABq, Δδ=119.4 Hz, J=19.0 Hz, 2H), 3.17 (ABq, Δδ=21.3 Hz, J=17.6 Hz, 2H); ¹³C NMR (acetone-d6) δ (ppm) 174.6, 172.1, 169.7, 74.9, 42.2, 41.3; HRMS (FAB) C₆H_{S}O₆ [M−H]⁺calcd 173.0086, found 173.0083.

### 3-(benzylcarbamoyl)-3-hydroxypentanedioic acid (26) and 2-(2-(benzylamino)-2-oxoethyl)-2-hydroxysuccinic acid (25)

To a solution of the citric acid anhydride 23 (0.50 g, 2.9 mmol) in dry CH₃CN (25 mL) was added benzylamine (0.47 mL, 4.3 mmol) dropwise and the resulting solution was stirred at room temperature. The reaction was fast and exothermic. The reaction mixture turned cloudy and finally oiled out at the bottom of the reaction flask. The reaction was allowed to stir for additional 2 h. After 2 h, 1N HCl (25 mL) was added and the stirred mixture was extracted with EtOAc. The combined organic layers were dried over Na₂SO₄ and evaporated under reduced pressure to give the crude product as the mixture of 25 and 26 (0.71 g, 86%). The ratio of 25 and 26 was calculated to be 2:1 from ¹H NMR and reversed phase (C-18 column) HPLC experiments of the crude. The carboxylic acids 25 and 26 were converted to methyl esters so that they can be separated by column chromatography.

### Dimethyl 3-(benzylcarbamoyl)-3-hydroxypentanedioate (28) and dimethyl 2-(2-(benzylamino)-2-oxoethyl)-2-hydroxysuccinate (27)

To a solution of the mixture of regioisomers 26 and 25 (0.60 g, 2.13 mmol) in a 1:1 mixture of dry MeOH and Et₂O (20 mL) was added TMSCHN₂ (0.95 mL, 6.40 mmol) and the resulting solution was stirred at room temperature for 30 min. The solvent was evaporated under reduced pressure and the residue was purified by column chromatography (SiO₂, hexane/EtOAc gradient) to give the products 27 (0.28 g, 43%) as the major and 26 (0.13 g, 20%) as minor regioisomers.

Compound 27: IR (neat) 3393 (br), 2953, 1735, 1655, 1201 cm⁻¹; ¹H NMR (CDCl₃) δ (ppm) 7.26-7.15 (m, 5H), 4.87 (br s, 1H), 4.36 (d, J=6.0 Hz, 2H), 3.57 (s, 6H), 2.81 (ABq, Db=47.6 Hz, J=15.7 Hz, 4H); ¹³C NMR (CDCl₃) 6 (ppm) 173.0, 171.7, 138.0, 128.7, 127.8, 127.5, 74.5, 52.1, 43.5, 41.7; HRMS (FAB) C₁₅H₂₀NO₆ [M+H]⁺calcd 310.1291, found 310.1286.

Compound 26: IR (neat) 3359 (br), 2954, 1736, 1648, 1211 cm⁻¹; ¹H NMR (CDCl₃) δ (ppm) 7.26-7.15 (m, 5H), 6.39 (br s, 1H), 4.34 (d, J=5.8 Hz, 2H), 3.69 (s, 3H), 3.59 (s, 3H), 2.77 (ABq, Δδ=37.6 Hz, J=15.8 Hz, 2H), 2.63 (ABq, Δδ=34.3 Hz, J=14.7 Hz, 2H); ¹³C NMR (CDCl₃) δ (ppm) 174.1, 170.7, 169.2, 138.0, 128.8, 127.8, 127.7, 73.9, 53.3, 52.2, 44.4, 43.7, 42.9; HRMS (FAB) C₁₅H₂₀NO₆ [M+H]⁺calcd 310.1291, found 310.1282, fragmentation pattern was different from that of compound 27.

Polymer-Supported Citrate 21(22).

To a suspension of aminomethyl resin (2.0 g, 2.2 meq/g, 4.4 mmol of —NH₂, Aldrich 564095, macroporous 30-60 mesh) in CH₃CN (10 ml) was added anhydride 23 (2.3 g, 13.2 mmol) and allowed to shake in orbital shaker for 15 h at rt. The resin was filtered and washed 3 times each with CH₃CN, H₂O, 1N HCl, H₂O, MeOH and Et₂O. It was then dried under reduced pressure to obtain light colored resin (2.6 g). IR (ATR): 3420-2500 (br), 3027, 2920, 1720 (C═O acid), 1640, 1597, 1180, 698 cm⁻¹. EA: C, 78.21%; H, 7.03%; N, 2.62%.

Polymer-supported tris(2-aminomethyl)amine (30a,b).

Hodges J. C., Booth R. J. J. Am. Chem. Soc. 1997, 119, 4882.

30a:

To a suspension of chloromethyl polystyrene resin (3.0 g, 0.82 mmol/g, 2.46 mmol of Cl, ChemPep G20J1233, macroporous 100-200 mesh) in DMF (10 ml) was added tris(2-aminoethyl)amine (1.45 ml, 9.89 mmol) and the suspension was shaken using an orbital shaker for 6 h at 65° C. The resin was filtered and washed 3 times each with DMF, MeOH, Et₃N, MeOH and Et₂O. The resin was then dried under reduced pressure to obtain white colored resin (3.0 g). IR (ATR): 3023, 2921, 1597, 1493, 1452, 697 cm⁻¹. EA: C, 87.96%; H, 7.77%, N, 1.97%; Cl, 0.65%. Loading value=0.35 mmol/g of tetramine (based on % N).

30b:

To a suspension of chloromethyl polystyrene resin (3.0 g, 1.24 mmol/g, 3.72 mmol of Cl, chloromethylated XAD 4) in DMF (10 ml) was added tris(2-aminoethyl)amine (2.17 ml, 14.88 mmol) and shaken using an orbital shaker for 6 h at 65° C. The resin was filtered and washed 3 times each with DMF, MeOH, Et₃N, MeOH and Et₂O. The resin was dried under reduced pressure to obtain white colored resin (3.1 g). IR (ATR): 3370 (br), 3019, 2922, 1603, 1447, 708 cm⁻¹. EA: C, 77.48%; H, 8.01%; N, 3.64%; Cl, 3.70%. Loading value=0.65 mmol/g of tetramine (based on % N).

Polymer-supported tren-citrate (31a,b).

31a:

To a suspension of polymer-supported tris(2-aminomethyl)amine 30a (1.50 g, 0.35 mmol/g, 0.52 mmol of —NH₂) in CH₃CN (8 ml) was added anhydride 23 (0.54 g, 3.12 mmol) and shaken using an orbital shaker for 15 h at rt. The resin was filtered and washed 3 times each with CH₃CN, H₂O, 1N HCl, H₂O, MeOH and Et₂O. It was then dried under reduced pressure to obtain off-white colored resin (1.65 g). IR (ATR): 3400-2500 (br), 3025, 2921, 1724 (C═O acid), 1650, 1601, 1452, 697 cm⁻¹. EA: C, 82.20%; H, 7.48%; N, 1.75%.

31b:

To a suspension of Polymer-supported tris(2-aminomethyl)amine 30b (1.50 g, 0.65 mmol/g, 0.97 mmol of —NH₂) in CH₃CN (8 ml) was added anhydride 23 (1.02 g, 5.85 mmol) and was shaken using an orbital shaker for 15 h at rt. The resin was filtered and washed 3 times each with CH₃CN, H₂O, 1N HCl, H₂O, MeOH and Et₂O. It was then dried under reduced pressure to obtain light colored resin (1.86 g). IR (ATR): 3400-2500 (br), 2925, 1724 (C═O acid), 1653, 1604, 1444, 1190, 708 cm⁻¹. EA: C, 70.02%; H, 6.98%; N, 2.97%.

What is claimed is:

1. A composition for the removal of metal ions from an aqueous solution, the composition comprising a polymer and at least one ligand selected from the group consisting of a dithiol compound and a citrate compound, wherein said at least one ligand is immobilized to the polymer.

2. The composition of claim 1, wherein the at least one ligand is immobilized to the polymer by a covalent bond.

3. The composition claim 1, wherein the at least one ligand is immobilized to the polymer through a branched linker scaffold.

4. The composition claim 2, wherein the at least one ligand is immobilized to the polymer through a branched linker scaffold.

5. The composition of claim 1, wherein the at least one ligand is immobilized to the polymer through an amide linkage.

6. The composition of claim 2, wherein the at least one ligand is immobilized to the polymer through an amide linkage.

7. The composition of claim 3, wherein the at least one ligand is immobilized to the polymer through an amide linkage.

8. The composition of claim 4, wherein the at least one ligand is immobilized to the polymer through an amide linkage.

9. The composition of claim 1, wherein the polymer comprises a polymer selected from the group consisting of polystyrene, polyacrylate, sepharose, and silica gel.

10. The composition of claim 2, wherein the polymer comprises a polymer selected from the group consisting of polystyrene, polyacrylate, sepharose, and silica gel.

11. The composition of claim 3, wherein the polymer comprises a polymer selected from the group consisting of polystyrene, polyacrylate, sepharose, and silica gel.

12. The composition of claim 4, wherein the polymer comprises a polymer selected from the group consisting of polystyrene, polyacrylate, sepharose, and silica gel.

13. The composition of claim 5, wherein the polymer comprises a polymer selected from the group consisting of polystyrene, polyacrylate, sepharose, and silica gel.

14. The composition of claim 6, wherein the polymer comprises a polymer selected from the group consisting of polystyrene, polyacrylate, sepharose, and silica gel.

15. The composition of claim 7, wherein the polymer comprises a polymer selected from the group consisting of polystyrene, polyacrylate, sepharose, and silica gel.

16. The composition of claim 8, wherein the polymer comprises a polymer selected from the group consisting of polystyrene, polyacrylate, sepharose, and silica gel.

17. The composition of claim 9, wherein the polymer comprises polystyrene.

18. The composition of claim 10, wherein the polymer comprises polystyrene.

19. The composition of claim 11, wherein the polymer comprises polystyrene.

20. The composition of claim 12, wherein the polymer comprises polystyrene.

21. The composition of claim 13, wherein the polymer comprises polystyrene.

22. The composition of claim 14, wherein the polymer comprises polystyrene.

23. The composition of claim 15, wherein the polymer comprises polystyrene.

24. The composition of claim 16, wherein the polymer comprises polystyrene.

25. The composition of any of claims 1 to 24, wherein the at least one immobilized ligand comprises a dithiol compound.

26. The composition of claim 25, wherein the immobilized dithiol compound comprises dimercaptosuccinic acid.

27. The composition of any of claims 1 to 24, wherein the at least one immobilized ligand comprises a citrate compound.

28. A method for the removal of metal ions from an aqueous solution, the method comprising contacting the aqueous solution with a composition comprising a polymer and at least one ligand selected from the group consisting of a dithiol compound and a citrate compound, wherein said at least one ligand is immobilized to the polymer.

29. The method of claim 28, wherein the at least one ligand is immobilized to the polymer by a covalent bond.

30. The method of claim 28, wherein the at least one ligand is immobilized to the polymer through a branched linker scaffold.

31. The method of claim 29, wherein the at least one ligand is immobilized to the polymer through a branched linker scaffold.

32. The method of claim 28, wherein the at least one ligand is immobilized to the polymer via an amide linkage.

33. The method of claim 29, wherein the at least one ligand is immobilized to the polymer via an amide linkage.

34. The method of claim 30, wherein the at least one ligand is immobilized to the polymer via an amide linkage.

35. The method of claim 31, wherein the at least one ligand is immobilized to the polymer via an amide linkage.

36. The method of claim 28, wherein the polymer comprises a polymer selected from the group consisting of polystyrene, polyacrylate, sepharose, and silica gel.

37. The method of claim 29, wherein the polymer comprises a polymer selected from the group consisting of polystyrene, polyacrylate, sepharose, and silica gel.

38. The method of claim 30, wherein the polymer comprises a polymer selected from the group consisting of polystyrene, polyacrylate, sepharose, and silica gel.

39. The method of claim 31, wherein the polymer comprises a polymer selected from the group consisting of polystyrene, polyacrylate, sepharose, and silica gel.

40. The method of claim 32, wherein the polymer comprises a polymer selected from the group consisting of polystyrene, polyacrylate, sepharose, and silica gel.

41. The method of claim 33, wherein the polymer comprises a polymer selected from the group consisting of polystyrene, polyacrylate, sepharose, and silica gel.

42. The method of claim 34, wherein the polymer comprises a polymer selected from the group consisting of polystyrene, polyacrylate, sepharose, and silica gel.

43. The method of claim 35, wherein the polymer comprises a polymer selected from the group consisting of polystyrene, polyacrylate, sepharose, and silica gel.

44. The method of claim 36, wherein the polymer comprises polystyrene.

45. The method of claim 37, wherein the polymer comprises polystyrene.

46. The method of claim 38, wherein the polymer comprises polystyrene.

47. The method of claim 39, wherein the polymer comprises polystyrene.

48. The method of claim 40, wherein the polymer comprises polystyrene.

49. The method of claim 41, wherein the polymer comprises polystyrene.

50. The method of claim 42, wherein the polymer comprises polystyrene.

51. The method of claim 43, wherein the polymer comprises polystyrene.

52. The method of any of claims 28 to 51, wherein the immobilized ligand comprises a dithiol compound.

53. The method of claim 52, wherein the immobilized dithiol compound comprises dimercaptosuccinic acid.

54. The method of claim 52, wherein at least one of the metal ions is selected from the group consisting of lead, mercury, cadmium, and arsenic ions, and wherein the immobilized ligand comprises a dithiol compound.

55. The method of claim 53, wherein at least one of the metal ions is selected from the group consisting of lead, mercury, cadmium, and arsenic ions, and wherein the immobilized dithiol compound comprises dimercaptosuccinic acid.

56. The method of claim 54, wherein the at least one metal ion is Pb²⁺and wherein the immobilized ligand comprises a dithiol compound.

57. The method of claim 55, wherein the at least one metal ion is Pb²⁺and wherein the immobilized dithiol compound comprises dimercaptosuccinic acid.

58. The method of any of claims 28 to 51, wherein the immobilized ligand comprises a citrate compound.

59. The method of claim 58, wherein at least one of the metal ions is a trivalent metal ion and the immobilized ligand comprises a citrate compound.

60. The method of claim 59, wherein the at least one metal ion is Fe³⁺and the immobilized ligand comprises a citrate compound.

61. The method of claim 58, wherein the aqueous solution has a pH of about 5 or less.

62. The method of claim 59, wherein the aqueous solution has a pH of about 5 or less.

63. The method of claim 60, wherein the aqueous solution has a pH of about 5 or less.

64. A method for producing a composition for the removal of metal ions from an aqueous solution, the method comprising immobilizing at least one ligand selected from the group consisting of a dithiol compound and a citrate compound to a polymer.

65. The method of claim 64, wherein the at least one ligand is immobilized to the polymer by a covalent bond.

66. The method of claim 64, wherein the at least one ligand is immobilized to the polymer through a branched linker scaffold.

67. The method of claim 65, wherein the at least one ligand is immobilized to the polymer through a branched linker scaffold.

68. The method of claim 64, wherein the at least one ligand is immobilized to the polymer via an amide linkage.

69. The method of claim 65, wherein the at least one ligand is immobilized to the polymer via an amide linkage.

70. The method of claim 66, wherein the at least one ligand is immobilized to the polymer via an amide linkage.

71. The method of claim 67, wherein the at least one ligand is immobilized to the polymer via an amide linkage.

72. The method of claim 64, wherein the polymer comprises a polymer selected from the group consisting of polystyrene, polyacrylate, sepharose, and silica gel.

73. The method of claim 65, wherein the polymer comprises a polymer selected from the group consisting of polystyrene, polyacrylate, sepharose, and silica gel.

74. The method of claim 66, wherein the polymer comprises a polymer selected from the group consisting of polystyrene, polyacrylate, sepharose, and silica gel.

75. The method of claim 67, wherein the polymer comprises a polymer selected from the group consisting of polystyrene, polyacrylate, sepharose, and silica gel.

76. The method of claim 68, wherein the polymer comprises a polymer selected from the group consisting of polystyrene, polyacrylate, sepharose, and silica gel.

77. The method of claim 69, wherein the polymer comprises a polymer selected from the group consisting of polystyrene, polyacrylate, sepharose, and silica gel.

78. The method of claim 70, wherein the polymer comprises a polymer selected from the group consisting of polystyrene, polyacrylate, sepharose, and silica gel.

79. The method of claim 71, wherein the polymer comprises a polymer selected from the group consisting of polystyrene, polyacrylate, sepharose, and silica gel.

80. The method of claim 72, wherein the polymer comprises polystyrene.

81. The method of claim 73, wherein the polymer comprises polystyrene.

82. The method of claim 74, wherein the polymer comprises polystyrene.

83. The method of claim 75, wherein the polymer comprises polystyrene.

84. The method of claim 76, wherein the polymer comprises polystyrene.

85. The method of claim 77, wherein the polymer comprises polystyrene.

86. The method of claim 78, wherein the polymer comprises polystyrene.

87. The method of claim 79, wherein the polymer comprises polystyrene.

88. The method of any of claims 64 to 87, wherein the at least one immobilized ligand comprises a dithiol compound.

89. The method of claim 88, wherein the immobilized dithiol compound comprises dimercaptosuccinic acid.

90. The method of any of claims 64 to 87, wherein the at least one immobilized ligand comprises a citrate compound.
